(19) United States
(12) Patent Application Publication
(10) Pub. No.: US 2020/0201295 A1
(43) Pub. Date: Jun. 25, 2020

(54) METHODS AND PRODUCTION STATIONS FOR IDENTIFYING WORKPIECES WITH A MOBILE UNIT

(71) Applicant: TRUMPF Werkzeugmaschinen GmbH + Co. KG, Ditzingen (DE)

(72) Inventors: Jens Ottnad, Karlsruhe (DE); Ulrich Schneider, Stuttgart (DE); Benjamin Schwarz, Korntal-Muenchingen (DE); Korbinian Weiss, Korntal (DE)

(21) Appl. No.: 16/807,559

(22) Filed: Mar. 3, 2020

Related U.S. Application Data
(63) Continuation of application No. PCT/EP2018/071162, filed on Aug. 3, 2018.

(30) Foreign Application Priority Data
Sep. 5, 2017 (DE) 102017215608.2

(51) Int. Cl. G05B 19/418

(52) U.S. Cl. CPC G05B 19/4183; G05B 2219/31268; G05B 2219/31312; G05B 19/4189

(57) ABSTRACT

A method for identifying workpieces that are distributed in a sorted manner to multiple workpiece collection units and brought to the workpiece collection units using an automation device. Included is identifying elements for emitting and receiving electromagnetic signals to and from transceiver units situated on the workpiece collection units to determine the position of the identifying elements from transit times of the electromagnetic signals between the transceiver units and the identifying elements. The identifying elements each bear information regarding the workpieces on the workpiece collection units. The identifying elements, which are provided by a delivery device and each bear information regarding the workpieces on the workpiece collection units, are brought from the location of a delivery device to a transfer zone in the working area of the automation device. The automation device brings each provided identifying element from the transfer zone to the associated workpiece collection unit.

### CROSS REFERENCE TO RELATED APPLICATIONS

This application is a continuation of and claims priority under 35 U.S.C. § 120 from PCT Application No. PCT/EP2018/071162, filed on Aug. 3, 2018, which claims priority from German Application No. 10 2017 215 608.2, filed on Sep. 5, 2017. The entire contents of each of these priority applications are incorporated herein by reference.

### TECHNICAL FIELD

The disclosure relates to methods for identifying workpieces, wherein a production machine produces a plurality of workpieces and the produced workpieces are distributed to multiple workpiece collection units in a sorted manner. The disclosure further relates to production stations for workpieces.

### BACKGROUND

Many different sheet-metal parts are required when constructing machines and equipment. Typical production machines, such as laser-cutting machines or punching machines, usually manufacture a plurality of different types of workpiece from one piece of sheet metal in quick succession. By an automation device, the workpieces are brought to provision locations on workpiece collection apparatuses, where the workpieces of one particular type are collected, for example stacked on a pallet.

For it to be easy to track the flow of material in a complex manufacturing plant, workpiece identifiers are useful, in particular for small batch sizes that require many manual control operations. Typically, the workpieces on a particular workpiece collection apparatus are provided with a routing slip, which contains important information regarding the designated workpieces, such as part type, order number, processing stations to be traversed, etc. The routing slips are usually manually arranged on or attached to the workpiece collection apparatus by an employee. This procedure is time-consuming, and mistakes and therefore incorrect parts declarations by the employee can easily occur. In addition, the employee can simply forget to attach the routing slip or the routing slip can get lost.

It is also possible to directly label workpieces, for example by engraving or laser inscription. However, this is time-consuming (often associated with interruptions in production time), generally irreversible, and can only provide a small amount of information.

Workpieces often have to be manually logged in (booked into) and out of the processing stations. Production orders are tracked during manufacturing operation with difficulty. Changes made to the production order are implemented with a large amount of manual work and time spent.

### SUMMARY

The systems and methods described herein can advantageously allow one to identify workpieces in a simple and cost-effective manner and to thus fulfill production orders in a more transparent and controllable manner.

In some embodiments, one couples a provision device for identifying elements to the automation device such that provided identifying elements can be handled (e.g., gripped and/or moved and/or released) as workpieces (acceptable parts) by the automation device and can each be brought or sorted to the workpieces to be identified in the associated workpiece collection units (or provision locations). As a result, the automation device, which is used for transporting the produced workpieces from the production machine to the workpiece collection units, is also used for transporting the identifying elements to the workpiece collection units. The identifying elements provided by the provision device need only be provided in the working region of the automation device, which is generally easily possible (automatically) and be mechanically suitable or configured for being handled by the automation device (for example in terms of a minimum size of clamping edges for applying clamping jaws or of a planar suction surface for applying a suction gripper). As during the sorting of the workpieces, the automation device is also actuated during the sorting of the identifying elements, such that the identifying elements can each be allocated to the desired workpiece collection unit (or provision location) virtually without any additional effort. A separate machine for sorting the identifying elements or for arranging the identifying elements on the workpiece collection units is not necessary.

In general, the provision device receives identifying elements from a store that initially do not bear, either directly or indirectly, information regarding workpieces. After the processing in the provision device, the information is directly or indirectly available by the provided identifying elements via the workpieces on the associated workpiece collection units. In general, the provision device contributes to storing the information on the identifying elements and/or to allocating the information to the identifying elements, typically in conjunction with a control device and/or a database.

The provision device can include a writing device by which the identifying elements containing the information regarding the workpieces is directly written. Alternatively or additionally, the writing device can write an allocation identifier (for example an alphanumerical code) for this information on the identifying elements. The “provided identifying elements” can also be referred to as “written identifying elements.”

Alternatively or additionally, the provision device can also include an ascertaining device (or detecting device), which ascertains an allocation identifier (for example an alphanumerical code) that is already (e.g., permanently) applied to the identifying elements. The ascertaining device can read out the allocation identifier that has already been applied to the identifying elements by a reading device. Alternatively or additionally, the ascertaining device can indirectly ascertain the allocation identifier that has already been applied to the identifying elements, for example by counting the identifying elements. For this purpose, the identifying elements can be supplied to the provision device in a predetermined order, with the allocation of the order of identifying elements to their allocation identifier being known to a superordinate control device, in particular using an external database, or to the provision device. Therefore, a writing or reading device is not required. Information regarding the workpieces can be transferred to the identifying elements (or machines or humans) even later using the allocation identifier, e.g., if the identifying elements include their own control module including a receiver. In this way, each identifying element is unambiguously allocated to the associated workpiece collection unit by an allocation identifier.

By the sorted identifying elements, the different workpieces are identified on the workpiece collection units and can be clearly identified, allocated and retrieved in subsequent manufacturing steps. For example, when the workpieces are at the subsequent manufacturing station, the appropriate manufacturing program can be easily ascertained and loaded.

In summary, the available automation axes can be synergistically utilized and the mechanical complexity for integration, in particular of the provision device, is low. It is simple for the method to be retroactively applied to an existing combination of production machine and automation device. The identifying elements can be sorted largely or even completely during the production time. The identifying element can be used to close an information gap between the cloud, an Enterprise-Resource-Planning (ERP) system, and the production machine.

A workpiece collection unit can for example be a pallet or a partial region of a pallet where the workpieces are set down and stacked on top of one another (“stacking space”); optionally, a plurality of stacking spaces and thus a plurality of workpiece collection units can be provided on one pallet. Likewise, a workpiece collection unit can be a pallet on which a plurality of workpieces are set down beside one another. A workpiece collection can also be a container into which the workpieces are placed. Generally, only workpieces of the same type are arranged on one workpiece collection unit. A plurality of workpiece collection units can be combined for joint handling (in particular transport) on a joint workpiece collection apparatus. A workpiece collection apparatus may for example be a pallet including a plurality of stacking spaces. A workpiece collection apparatus can also be a roller carriage on which a plurality of containers are arranged or formed.

Typically, at least five workpiece collection units are loaded with workpieces in parallel with one another and each is provided with an identifying element (usually as a final step). Once the workpiece collection units have finished being loaded with workpieces at their provision locations, they are replaced with empty workpiece collection units.

The identifying elements are typically standardized (i.e., identical for a plurality of types of workpiece, usually all present types of workpiece) and include a carrier on which the information and/or an allocation identifier is written (for example, by an imprint or electronically) and/or on which an allocation identifier is permanently stored (for example printed or programmed). A plurality of identifying elements are typically stored on the provision device.

Typically, the production machine produces workpieces of different types in quick succession which are continuously sorted to the workpiece collection units by the automation device.

The automation device can include a plurality of components, each of which only covers part of the transport path and/or is responsible for different workpiece types. The following two methods for automated workpiece sorting can be applied individually or in combination:

1. Workpieces are picked up by grippers and stacked on pallets.

2. Workpieces are dropped into containers/crates.

In a combination, typically smaller workpieces/parts (usually bulk goods) are ejected into the crates in a sorted manner and larger workpieces/parts are stacked on a pallet. The workpieces are, for example, parts that have been cut to shape, such as sheet-metal parts. The automation device for example includes a suction gripper or an intermediate workpiece storage point including a downstream workpiece chute and workpiece carriage including an ejector flap.

The information regarding the (generally identical) workpieces on a workpiece collection unit includes, for example, the type of workpiece (usually as a type number), the production time (usually as the production date), a production site (for example by stating the factory or a production line), an order identifier (usually an order number), a purchaser (customer) and/or production sequence information (for example the next processing station).

In the simplest case, the identifying element is printed with a color to display information. The identifying element can also include a display in the form of electronic paper, which is known as an e-ink display. This display can be changed by electromagnetic signals. In this way, the information regarding the workpieces on a workpiece collection unit (or the order allocated to the workpieces or workpiece collection unit) can be displayed on the identifying element. An identifying element itself can include a control element (control module) for the display (e.g., an e-ink display).

The identifying elements are in the form of mobile units for emitting and receiving electromagnetic signals to and from transceiver units. The position of the mobile units can be determined from propagation times of the electromagnetic signals between the transceiver units and the identifying elements. This significantly simplifies the production sequences, since the mobile units can be located. As a result, production orders can be monitored and amended more easily. A large part of the time taken to book the workpieces into the processing stations is no longer required.

The identifying elements can be configured for emitting and receiving electromagnetic signals in the form of ultra-wideband signals (UWB). As a result, the mobile units can be located in a particularly precise manner. In some embodiments, the mobile units each include a housing in the form of a planar box.

In some embodiments, electromagnetic signals are transmitted between at least one identifying element and a transceiver unit. The position of the identifying element is determined on the basis of the propagation times of the electromagnetic signals between the transceiver units and the identifying element.

By indoor positioning and an indoor positioning system, the positioning of the identifying elements can take place solely by an analysis unit, e.g., without manual interaction. Previous systems for positioning workpieces or orders in manufacturing plants have the drawback that lost workpieces or orders have to be sought manually. It has been found that these manual seeking processes, in particular in manufacturing plants having a high number of small, constantly changing orders, e.g., in job-order manufacturing plants, make up an extremely high proportion of the non-productive time. Using the positioning methods and systems described herein, the positions of the workpieces and thus the orders can be called up, filtered, and/or located in a targeted manner on a screen, for example. The need for time-consuming manual processes searching for workpieces, but also for tools or persons, can thus be drastically reduced, in particular in (steel working and/or sheet-metal working) industrial manufacturing.

The concepts described herein are based on the use of a 2D/3D indoor positioning system as a starting point for the location-dependent information processing. The positioning system, in particular the identifying elements, may optionally be equipped with further sensor technology, for example with acceleration and/or position sensors, and thus further act as a starting point for position-dependent information processing. This allows for location-dependent (and optionally position-dependent) interaction in the 2D/3D indoor positioning system during manufacturing control and allows manufacturing processes to be optimized. For example, virtual barriers (gates) and zones can be used to monitor and control a manufacturing process and downstream production steps in an automated manner. These methods can be carried out in real time.

It has been found that the use of such positioning systems is also possible in the specific environment of steel working and/or sheet-metal working industrial manufacturing. Such positioning systems can be integrated in a manufacturing control system (also referred to herein as a manufacturing execution system (MES)). By taking into account the expected processes in a manufacturing facility, the use of such positioning systems is possible despite the available steel and sheet metal that can reflect and shield the electromagnetic signals used. The systems can still be used even when the metal workpieces are also moved in terms of their location, and the position and orientation of the reflection surfaces is thus constantly changing.

When using 2D/3D indoor positioning systems, a level of complexity may arise during the dynamic allocation of obtained position information to physical components. The concepts disclosed herein address this complexity and make it possible, for example, to allocate production orders having an allocated identifier without the complex interaction of a mobile unit, by which the position information to be allocated is obtained.

Indoor positioning systems allow material flows in the manufacturing within a manufacturing facility to be imaged in a detailed manner into the digital processing. The positioning systems make it easier to locate the objects/persons involved in the manufacturing within the production environment. If tools, equipment, or carriers are initially equipped with a locatable identifying element of the positioning system, these can be accordingly allocated to digital information in a manual or automated manner in the digital control system. This also relates to objects which are temporarily involved in the manufacturing, such as production orders or service personnel. Temporarily required dynamic allocations can arise repeatedly, and are only required in the manufacturing facility for a few hours, days, or weeks. To facilitate and ensure the dynamic allocation of the identifying elements to new production orders in a simple and reliable manner, the process aids proposed herein can be used.

The indoor positioning can be carried out using the method disclosed herein to an accuracy of less than 30 cm, e.g., less than 10 cm, in a manufacturing facility that cannot be reached by GPS satellite signals and has a floor area in the range of e.g., 1 hectare. This level of accuracy is generally not possible with other technologies (Bluetooth, WiFi, WLAN, infrared, mobile radio, or RFID). Many requirements need to be taken into account when positioning workpieces, orders, persons (operators), and/or tools.

Industrial manufacturing is increasingly geared towards manufacturing small batches having many individual working steps (manufacturing processes such as cutting, bending, grinding, surface treatment) at different workstations, such as machine workstations and manual workstations. Therefore, several hundred different orders that all require different working steps often need to be handled in one day. Once a disruption occurs, the manufacturing control can very quickly become very unclear. Semi-processed orders or orders that have not been processed at all are sought by individual persons in the manufacturing facility and the status thereof is ascertained, and this is time-consuming. This status is then transmitted to the manufacturing control. This can result in a considerable loss of time during the actual manufacturing.

Owing to the increasingly rapid processing steps during productive processing and as the number of different orders having increasingly small numbers of identical parts increases, such stoppages can occur increasingly frequently. The losses of time caused thereby reduce the productive time. If orders, workpieces, persons (e.g., operators), and tools are to be found rapidly, the positioning disclosed herein helps at least some of these units to reduce lost time. The positioning meets the very high requirements for industrial manufacturing.

Positioning in real time is the aim in industrial manufacturing. The positioning needs to be so accurate in terms of position that mobile units can be reliably found and/or the processing steps can be allocated. It has been become clear that positioning that is only accurate to 1 m is not sufficient for this purpose. Positioning which has to be re-calibrated every time the radiation behavior of electromagnetic waves changes, caused, e.g., by movement of metal workpieces in the manufacturing facility, is disadvantageous and often cannot be used. The positioning should also be flexible, it should be possible to combine several orders into one order, it should be possible to split one order into several orders, etc. The positioning should be simple to operate, and fail-safe.

In general, the concepts disclosed herein can make it possible to increase the process reliability, to optimize throughput times, and to accordingly optimize the production costs. Specifically, the concepts disclosed herein can bring about a significant time saving in the manufacturing process in some cases, the manufacturing process extending, e.g., from the production of a required quantity of parts through to the correct transfer to a subsequent process (e.g., a subsequent metal-processing step). Several orders can further be implemented virtually simultaneously with high process reliability. The concepts disclosed herein further allow for simple allocation of workpieces as part of the positioning system. Open orders can thus be optimized despite the complexity of several orders needing to be processed simultaneously.

It is possible to flexibly process different process sequences with the associated time saving if machines such as laser-cutting machines and/or punching machines are incorporated in the partially automated production process. The error prevention and the automatic, correct booking of workpieces, processing steps, etc., can form the basis for data-based real-time control of the metal processing (e.g., the steel and sheet-metal manufacturing). Accordingly, machine tools that are used when preparing small batch sizes of workpieces can also be integrated in manufacturing which is controlled by an MES as part of industry 4.0.

Aspects described herein are based in part on the knowledge that, with the accuracy and reliability of new positioning systems based on UWB technology, for example having a position-determining accuracy of less than 30 cm (e.g., less than 10 cm), the use of indoor positioning systems is possible in a useful manner as part of industrial manufacturing.

The positioning systems that are described herein and are intended for integration in industrial manufacturing are based on mobile units (also referred to herein as “tags” or “identifying elements”) and stationary transceivers (also referred to herein as “anchors”). During integration in industrial manufacturing, for determining the position of a workpiece, generally an object (“assets”), each of these is provided with at least one mobile unit and is brought into a functional or spatial relationship with the unit (also referred to herein as a physical or spatial allocation). The mobile units are generally electronic components which are capable of communicating with the transceivers by UWB communications technology. Each mobile unit can have its own time-determining unit (“clock”) for establishing propagation times.

The positioning system can include a plurality of transceiver units and at least one mobile unit. The positioning system can further cooperate with the MES. For example, an analysis unit of the positioning system can be part of the MES.

The transceiver units can be configured to transmit UWB radio signals to the mobile units and to receive UWB radio signals therefrom.

The distance between a spatially movable mobile unit and a transceiver unit that is e.g., installed in a fixed manner can be determined by the time the signal requires to cover the distance between the two units. If the distances of several transceiver units are ascertained of which each of the positions are already known, the spatial position of the mobile unit in relation to the transceiver units can be determined by triangulation, for example.

For determining a propagation time, the transceiver unit and the mobile unit(s) can have highly accurate clocks, which can accurately determine the time to a few nanoseconds or even to just fractions of a nanosecond. Even if the clocks in the transceiver unit and the mobile unit are highly accurate, the clocks are not necessarily synchronized. Different methods for synchronizing clocks or eliminating errors can be used following from the asynchronous clock progression. For example, one of the transceiver units, e.g., acting as the master positioning unit, can thus transmit a signal at a first time T1 and a second signal at a second time T2. The time difference T2-T1 can be known to the mobile unit or may be transmitted together with the signals, such that the unit can synchronize to the time of the transceiver units.

Alternatively, the mobile unit can transmit two signals in a known time interval Ta. The transceiver unit can ascertain the synchronization deviation on the basis of its own time measurement with its own clock from the reception of the first signal to the reception of the second signal and can calculate the deviation from the distance measurement. The time interval between the first signal and the second signal should be low so that the mobile unit has not moved significantly in this time. The time interval can be selected by the mobile unit such that it is a predetermined multiple or fraction of the time that the mobile unit requires from the reception of a signal to which it should respond through to the output of the first signal.

The transceiver units 13 can further be connected to the analysis unit by wireless or wired communication connections.

The mobile units can, for example, communicate via the transceiver units. Alternatively or additionally, the mobile units can independently communicate with the analysis unit/MES via other communication connections (for example, via a WLAN connection).

In general, the data communication of the transceiver units and the mobile units with a manufacturing-control system (MES), may be possible bidirectionally.

In some embodiments, WLAN transmitting stations can be integrated in the transceiver units of the positioning system for data access to the manufacturing-control system, such that digital data is accessible in the manufacturing facility via the transceiver units in a mobile manner, e.g., using smartphones or tablets. The integration of the WLAN transmitting stations in the transceiver units can simplify the installation and operation of a data-communication system in the manufacturing facility.

The UWB technology uses frequency ranges of, e.g., from 3 GHz to 5 GHz, the UWB technology using a relatively wide frequency range for forming signal curves (communications frameworks) that are strictly limited in terms of time. In order for it to be possible to locate an object that is transmitting radio waves as precisely as possible, a signal having very steep edges is used. This means that the signal has a rectangular signal curve over time rather than a sinusoidal curve. Thus, a signal is used in which a plurality of sinusoidal signals having different frequencies are superimposed. This is because a plurality of sinus signals having different frequencies can form a signal that has a steep edge and can approximate a substantially rectangular curve over time. This means that a plurality of frequencies from a wide-band frequency spectrum have to be available to form a signal. Accordingly, UWB technology, which has a wide-band frequency spectrum, is suitable for precise locating according to the present disclosure. The technology and the frequency band that can be used in UWB technology are described in the “IEEE 802.15-2015” standard, for example.

If the identifying element is written with an allocation identifier by the provision device or already bears an allocation identifier that is ascertained by the provision device and is allocated to the information regarding the workpieces in a database, the information regarding the workpieces on the workpiece collection unit is then typically retrieved from the identifying element by the allocation identifier via a data connection to the database (usually via a superordinate control device, in particular including an external database). The information is then displayed, for example on an e-ink display, and/or is made available for machine read-out. Likewise, the information can be retrieved from the database by machines or humans by the allocation identifier. The allocation identifier thus indirectly constitutes or provides the information regarding the workpieces on the workpiece collection unit.

An LED can be provided on the identifying element as an exposed element of the human-readable information. The LED can visually communicate coded information to the human by different colors, flashing frequencies or flashing patterns. A flashing LED is easier to recognize at long distances than a display, for example. Therefore, a signal device such as an LED has particular advantages if an identifying element is being sought. It can be addressed by an operator in a remote-controlled manner and can then be made noticeable by a signal device. Additionally or alternatively, it can output a noise signal. Such remote-controlled addressing can for example be carried out by another mobile unit or via another portable device, e.g., a smartphone or tablet, or via the analysis unit. It can, however, also be carried out directly, e.g., via near-field sensors (e.g., Bluetooth, NFC, or IR).

The identifying element can further include individual sensors or several different sensors for ascertaining the position, the acceleration, the movement in space by a gyrosensor, the temperature, magnetic field, electrical field, humidity, brightness, sound, vibrations, etc. These may be used for additional functions.

In some embodiments, the provision device directly writes the identifying elements to be provided with the information regarding the workpieces. Direct writing (using optically visible characters, or electronically) is particularly simple and allows direct access to the information without needing to access a control device or (external) database.

In some embodiments, the identifying elements provided by the provision device each bear an individual allocation identifier, and the information regarding the workpieces on the workpiece collection units is allocated in a database in each case to the allocation identifiers of the identifying elements that are provided or are to be provided. The allocation identifiers thus indirectly bear the information regarding the workpieces on the workpiece collection units. After reading off or reading out the allocation identifier of an identifying element, the allocated information regarding the workpieces can be retrieved from the database. A large amount of information, which is not limited by the printable size or the programmable capacity of the identifying element, can be made available thereby. In addition, the information can be easily updated in the database, if desired. Provided that the identifying element is equipped therefor (for example with its own control module and a receiver), it can subsequently also retrieve the allocated information (in full or in part) itself by its allocation identifier (for example via a WLAN), in particular to display the information on a display of the identifying element. It is important here to unambiguously allocate the identifying elements to the associated workpiece collection units by the allocation identifier, and this is carried out in cooperation with the provision device.

In some embodiments, the identifying elements to be provided by the provision device are each written with an allocation identifier. This is particularly simple and reliable. The identifying elements do not require any prior preparation with a fixed allocation identifier and/or with a known order.

In some embodiments, it is likewise possible for an allocation identifier permanently stored on the identifying elements to be provided to be read out by the provision device in each case. A writing device is not required on the provision device. The permanently stored allocation identifier may also be used again if the identifying element is used multiple times.

In some embodiments, the provision device removes the identifying elements to be provided from a store in which identifying elements having known, permanently stored allocation identifiers are stored in a known order, in particular wherein the identifying elements in the store form a stack, and that an allocation identifier for an identifying element to be provided is determined by removal information, wherein the removal information describes the position of the identifying element to be provided relative to the known order, in particular wherein the removal information is a number index of the identifying elements taken from the stack. The provision device does not require either a reading device or a writing device for the identifying elements. The information regarding the workpieces can be allocated to the allocation identifier of the identifying element by the removal information and the known order that is typically stored in the database.

In some embodiments, the provision device writes the identifying element in a machine-readable manner and/or in a manner that is readable by humans. Subsequent automation processes can be simplified by machine-readable labeling. Labeling that is readable by humans allows the workpieces to be identified without any further tools. For the purpose of machine-readable writing, a RFID chip can be programmed or a barcode or QR code can be printed. Writing that is readable by humans is typically carried out by printing with characters or images or by correspondingly actuating an electronic display (e.g., e-paper or e-ink).

In some embodiments, the provision device reversibly writes the identifying element is preferred. The identifying element can then easily be reused subsequently (for another workpiece collection unit containing other workpieces).

In some embodiments, the provision device programs an RFID chip of the identifying element is particularly preferred. The programming is typically reversible, e.g., the RFID chip can be re-programmed when the identifying element is re-used with other workpieces. The programming directly or indirectly contains the information regarding the workpieces and can be read out by an RFID reader. RFID makes it possible to read out the identifying element contactlessly (usually at a distance of a few meters) and largely independently of the orientation of the identifying means.

In some embodiments, the provision device prints the identifying element is also advantageous. Printing is possible in a comparatively cost-effective manner. The printing can be reversible, e.g., the identifying element can be re-printed when the identifying element is re-used with other workpieces (typically after suitable cleaning).

In some embodiments, it is provided that the automation device forms a stack of workpieces at least on some of the workpiece collection units in each case and applies an identifying element on top of or beside the stack of workpieces, in particular wherein at least some of the workpiece collection units each include a pallet or a partial region of a pallet on which the stack is formed in each case. By forming stacks, a large number of parts can be stored in a compact space and can advantageously be made available for automatic further handling. By arranging the identifying element on or beside the stack, the element is usually easy for workers to read and for machine readers to read out.

In some embodiments, the automation device forms a pile of workpieces at least on some of the workpiece collection units in each case and applies an identifying element on top of or beside the pile of workpieces, in particular wherein at least some of the workpiece collection units include a container, such as a closable container, in which the pile is formed. Large amounts of typically small parts can be effectively handled by containers. By arranging the identifying element on the pile (usually in the interior of the container) or beside the pile (usually outside the interior of the container, for example on a particular deposit point on the side of the container), the element is usually easy for workers to read and for machine readers to read out.

In some embodiments, the automation device includes gripping means and the gripping means grip both workpieces and also identifying elements, in particular wherein the gripping means suction the workpieces and the identifying elements. Gripping means are universally applicable and are mechanically gentle on the workpieces. Gripping means are typically used for stacking workpieces. Sheet-metal parts can be effectively handled using suction grippers. In principle, the same gripping means are used for the workpieces and the identifying elements.

In some embodiments, the automation device includes a workpiece carriage into which both workpieces and also identifying elements are placed via a workpiece funnel, and that the workpiece carriage moves at least over some of the workpiece collection units and, by opening an ejector, the workpieces and the identifying elements can drop out via a relevant workpiece collection unit. This variant is mechanically relatively simple and therefore cost-effective; substantially only the workpiece carriage needs to be moved (besides ejector mechanisms), and this can usually take place on a single linear axis. This variant is primarily suitable for forming workpiece piles in containers.

In some embodiments, the identifying element includes a card, such as a plastics card or a card coated with plastics material. The card can have at least a surface area of 45×80 mm, e.g., at least 50 mm×90 mm. The card is considerably heavier than paper while being the same size (surface area), and therefore gets lost less easily. The card is typically (reversibly) printed and/or contains or bears an RFID chip. The card can both be handled by a suction gripper and can be transported via ejectors and workpiece carriages. The use of plastics material is cost-effective and renders the card sufficiently robust for multiple uses.

The identifying elements can be brought to a transfer zone and from there can be transported to the associated workpiece and/or the associated workpiece collection unit by the automation device.

The scope of the present disclosure also includes a production station for workpieces including a production machine for producing a plurality of workpieces, an automation device for bringing the workpieces produced by the production machine to provision locations for workpiece collection units, a control device for actuating the automation device such that the produced workpieces are distributed to the provision locations in a sorted manner, a plurality of identifying elements in the form of mobile units for emitting and receiving electromagnetic signals to and from transceiver units to determine the position of the identifying elements from propagation times of the electromagnetic signals between the transceiver units and the identifying elements, wherein the production station further includes a provision device for providing identifying elements, wherein the identifying elements provided by the provision device each directly and/or indirectly bear information regarding the workpieces sorted to the provision locations, and a conveying unit for bringing the identifying elements provided by the provision device from the provision device to the associated workpieces or the associated workpiece collection unit.

Workpieces can be identified in a simple and cost-effective manner. The production station combines the production machine, the provision device, the conveying unit, the control device and the automation device in one location. The automation device can be used both for transporting the workpieces (from the production machine or an associated ejector space, for example on a workpiece funnel, to the provision location or a workpiece collection unit arranged there) and for transporting the identifying element (from a transfer zone to the provision location or a workpiece collection unit arranged there). The correct sorting both of the workpieces and of the identifying elements to the provision locations can be organized by the control device. This synergistic double use is particularly efficient. Usually, at least five provision locations for workpiece collection units are provided on one production station in the working space of the automation device.

The provision device can include a writing device for writing the identifying elements to be provided directly with the information for the workpieces sorted to each of the provision locations and/or with an allocation identifier for this information. By the writing device, the information itself and/or the allocation identifier can be easily and reliably applied to the identifying element. The writing can be carried out physically and/or electronically.

In some embodiments, the provision device includes a reading device for reading out allocation identifiers that are permanently stored in the identifying elements to be provided, or a determining device for determining the position of an identifying element to be provided relative to a known order in which identifying elements are stored in a store, in particular wherein the identifying elements in the store form a stack and the determining device includes a counting device for identifying elements taken from the stack. This makes it possible to ascertain and use (after allocation to the information regarding the workpieces) already existing, permanently stored (unambiguous) allocation identifiers; a writing device is not required. The reading device and determining device are examples of a detecting device, by which the already existing, permanent allocation identifiers of stored identifying elements can be ascertained.

In some embodiments, it is advantageous in which the conveying device includes a chute, via which the provided identifying elements can slide from the provision device into the transfer zone in the working region of the automation device. The chute is a particularly simple means for guiding identifying elements provided by the provision device into the working region of the automation device such that the automation device can further transport the identifying element to the provision location. The chute is passive and does not require any energy or control.

In some embodiments, the production machine is a flat-bed processing machine or a cutting machine, in particular a laser-cutting machine, or a punching machine, or a combined cutting and punching machine. In these types of production machine, a plurality of different types of workpiece are typically produced from one piece of raw material (usually a metal sheet), which workpieces are then collected on different workpiece collection units and can be identified in a simple manner.

In some embodiments, the production machine is a bending machine.

In some embodiments, the identifying elements rest on delivered workpiece collection units and are initially brought into a provision device by the workpiece collection units by a conveying unit. The workpieces are conveyed to the machine, in particular by an automation device, and at the machine are processed, for example bent by a bending machine, and are then brought to another workpiece collection unit, in particular by an automation device. The identifying elements allocated to the workpieces are likewise brought to this workpiece collection unit.

In some embodiments, the identifying elements each include an RFID chip. The RFID chip can be written and read out in a particularly simple manner, in particular also contactlessly and at a medium distance (from up to several meters). This makes it easier to automate subsequent manufacturing processes with the identified workpieces.

In some embodiments, the automation device includes a suction gripper, and that the identifying elements include a planar portion for applying the suction gripper, in particular wherein the identifying elements are in the form of cards. Using suction grippers, the workpieces and identifying elements can be comparatively easily and reliably handled, in particular without clamp axes. It is easily possible to form a planar portion on the identifying element, it being possible to provide the identifying elements with a compact, planar form, such as that of a card.

In some embodiments, the production station includes a plurality of workpiece collection units which are each arranged at an associated provision location, in particular wherein at least some of the workpiece collection units are a pallet and/or a partial region of a pallet and/or as a container for workpieces. By the workpiece collection units, the workpieces that are each set down thereon can be further handled in a simple manner, in particular can be moved together with a pallet or a container to a warehouse or a subsequent manufacturing station.

In some embodiments, the production station includes at least one workpiece collection apparatus, which includes a plurality of workpiece collection units which are transported together over the workpiece collection apparatus, in particular wherein the workpiece collection apparatus includes a roller carriage including a plurality of containers for workpieces and/or positioning spaces for stacks of workpieces, or includes a pallet including a plurality of positioning spaces for stacks of workpieces. By the workpiece collection units, it is possible to rapidly replace a larger number of workpiece collection units at once, for example if the workpiece collection units of the workpiece collection apparatus are full.

The production station can be configured to transport the identifying elements to a transfer zone and from there to transport the identifying elements to the associated workpiece and/or the associated workpiece collection unit by the automation device.

The identifying elements of the production station may be configured for emitting and receiving electromagnetic signals in the form of ultra-wideband signals (UWB). The mobile units can each include a housing in the form of a planar box.

Further advantages will become clear from the description and the drawings. Likewise, the above-mentioned features and those set out in the following can each be used in isolation or in any combination. The embodiments that are shown and described should not be understood to be definitive, but instead should be understood to set out the invention in an exemplary manner.

### DESCRIPTION OF DRAWINGS

FIG. 1 is a schematic view of a first production station as described herein, on which a first variant of a method is executed, using a laser-cutting machine, the produced workpieces being stacked.

FIG. 2 is a schematic view of a first production station as described herein, on which a second variant of a method is executed, using a punching machine, the produced workpieces being ejected into containers.

FIG. 3 is a schematic, partially transparent view of a printed identifying element as described herein.

FIG. 4 is a schematic, partially transparent view of an identifying element including an e-ink display.

FIG. 5 is a schematic view of a provision device as described herein that includes a reading device or a counting device.

FIG. 6 is a schematic view of a production facility showing the location of an identifying element in the production facility.

### DETAILED DESCRIPTION

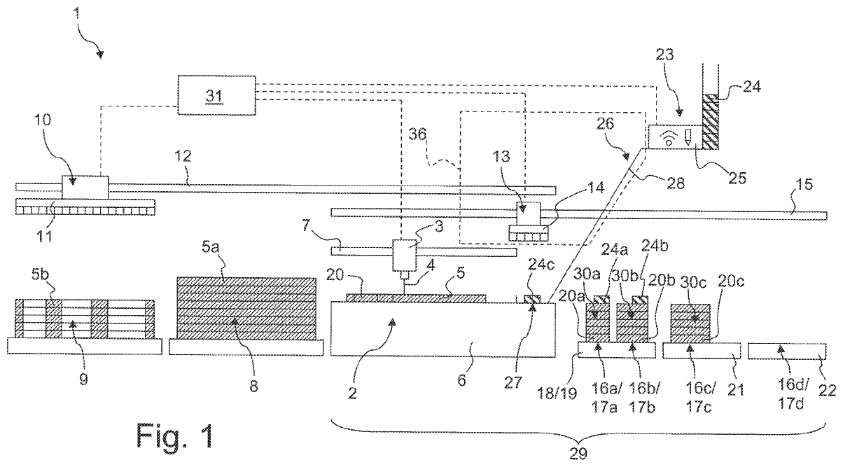

FIG. 1 is a schematic view of a first embodiment of a production station 1. The production station 1 includes a production machine 2, in this case a laser-cutting machine including a laser-machining head 3. During laser machining, the laser-machining head 3 emits a laser beam 4 which, in this case, is directed vertically downwards onto a piece of raw material 5 that is to be cut on a table 6. Here, the laser-machining head 3 can be moved in a horizontal plane above the table 6 using a gantry system 7 to move over desired cutting contours of workpieces 20 to be manufactured. Alternatively, an upper part of the table 6 could also be configured to move in a horizontal plane together with the piece of raw material 5.

Pieces of raw material 5a that are yet to be cut are stored in a stack 8 of raw material beside the table 6. Leftover pieces of raw material 5b that remain after all of the desired workpieces have been cut out are likewise stored in a stack 9 of leftover material beside the table 6. By a loading device 10, uncut pieces of raw material 5a can be brought to the table 6 from the stack 8 of raw material, and leftover pieces of raw material 5b can be brought to the stack 9 of leftover material from the table 6. In this case, the loading device 10 is configured to include a suction gripper 11 that can be moved in a horizontal plane and also vertically by a second gantry system 12.

By an automation device 13, the cut workpieces 20 can also be transported from the table 6 to provision locations 16a-16d that are beside the table 6. For this purpose, the automation device 13 has a suction gripper 14 which can be moved in a horizontal plane and also in a vertical direction by a third gantry system 15.

The automation device 13 can be understood to be part of the production machine 2. The same applies to the loading device 10.

Workpiece collection units 17a-17d are arranged at the provision locations 16a-16d. Here, the workpiece collection unit 17a is the left-hand partial region of a pallet 18, where a first type of workpiece 20a is stacked. The workpiece collection unit 17b is the right-hand partial region of the pallet 18, where a second type of workpiece 20b is stacked. The pallet 18 is therefore a workpiece collection unit 19 on which two workpiece collection units 17a, 17b are formed. The workpiece collection unit 17c can be a pallet 21 on which (only) a third type of workpiece 20c is stacked. The workpiece collection unit 17d is likewise formed by a pallet 22 on which workpieces 20 have not yet been arranged. Only four provision locations 16a-16d have been shown here for the purpose of simplification; in practice, usually at least five provision locations are provided.

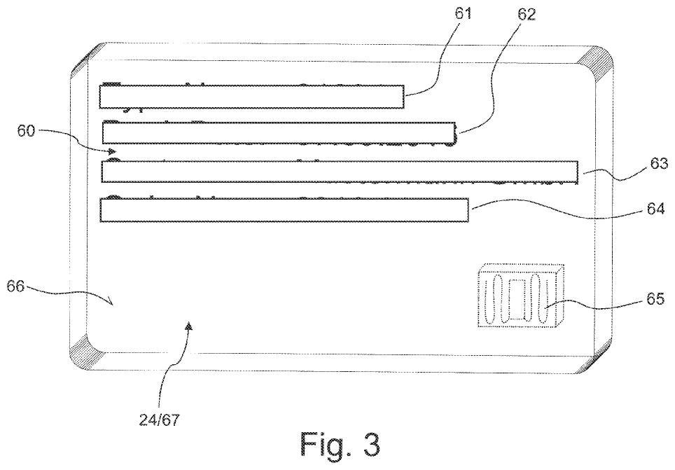

The production station 1 also has a provision device 23, on which, in the embodiment shown, identifying elements 24 stored thereon are written with direct information (for example an order number, a part type, a production time) regarding each of the workpieces 20a, 20b, 20c on the workpiece collection units 17a, 17b, 17c; for this purpose, the provision device 23 includes a writing device 25. Here, the writing device 25 applies an imprint to the identifying elements 24 and also programs RFID chips of the identifying elements 24 (not shown in greater detail, see FIG. 3 in this regard). The provision device 23 thus writes an identifying element 24 both physically and electronically.

The provision device 23 is coupled to the automation device 13 by a conveying device 26. Identifying elements 24 are ejected from the provision device 23 and slide down a chute 28 of the conveying device 26 into a transfer zone 27, which is within the working space 29 of the automation device 13, e.g., the space that can be reached by the suction gripper 13. In the present case, the identifying element 24c has already slid into the transfer zone 27. By the automation device 13, the identifying element 24c can then be brought to its associated stack 30c of workpieces 20c and applied to the stack 30c. Identifying elements 24a, 24b have already been applied in this way to the stacks 30a and 30b of workpieces 20a, 20b.

Once the stacks 30a, 30b, 30c of workpieces 20a, 20b, 20c have been completely formed and the identifying elements 24a, 24b, 24c have also been applied thereto, the workpiece collection units 17a, 17b, 17c or the pallets 18, 21 are replaced with empty workpiece collection units or empty pallets (not shown in greater detail); for this purpose, the pallets 18, 21 can be handled in a conventional manner, for example using a forklift truck. The two stacks 30a and 30b can be handled at the same time by the pallet 18.

The loading device 10, the production machine 2, the automation device 13 and the provision device 23 are coordinated by a control device 31 (if the conveying device 26 also requires actuation in other embodiments, the conveying device 26 can also be coordinated by the control device 31). The control device 31 determines how the workpieces 20, 20a, 20b, 20c are sorted to the provision locations 16a-16d and also ensures that the identifying elements 24a, 24b, 24c are correctly allocated. Here, the control device 31 also provides the workpiece-related information which is written on and/or allocated to an identifying element 24, 24a, 24b, 24c by the provision device 23.

It should be noted that, by the provision device 23 or the writing device 25, an allocation identifier can also be written on a relevant identifying element 24 instead of or in addition to the direct information regarding the workpieces.

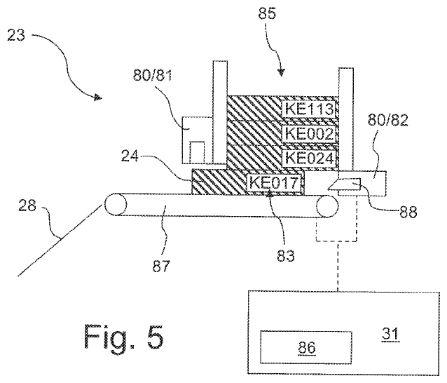

Referring to FIG. 5, the provision device 23 can also be configured to ascertain a relevant unambiguous allocation identifier 83 that is already permanently (physically and/or electronically) applied to the stored identifying elements 24, for example by reading out or counting the allocation identifier. The provision device 23 then includes an ascertaining device 80, typically in the form of a reading device 81, that reads out the allocation identifiers 83 of provided identifying elements 24 when they are withdrawn on a conveyor belt 87. The ascertaining device 80 can also be in the form of a counting device 82 (in this case configured to include a push button 88) which counts which identifying element 24 is currently being withdrawn from the stored stack 85 of identifying elements 24, the sequence of allocation identifiers 83 in the stack 85 being known. The provision device 23 may also be a combination of an ascertaining device 80 and a writing device 25.

The ascertained allocation identifier 83 is allocated to the information regarding the workpieces on the assigned workpiece collection unit in a database 86, such that the information is easy to find or retrieve by the allocation identifier 83. Subsequently, the identifying element 24 then typically directly retrieves the actual information regarding the workpieces from the database 86 by the allocation identifier 83. Likewise, the actual information can be subsequently retrieved by machines or humans by the allocation identifier 83 as required. The database 86 can be part of the controller 31 (as shown) or can be an external database. The same applies to the case of an allocation identifier 83 applied to an identifying element 24 by a writing device 25 of a provision device 23.

The production station 1 shown in FIG. 1 can be configured such that an existing production plant that includes a production machine 2, a loading device 10, an automation device 13, and a control device 31 is retrofitted with a provision device 23 and a conveying device 26 having a transfer zone 27 in the working space of the automation device 13, and the control device 31 is re-programmed such that it also takes over the sorting of the identifying elements 24.

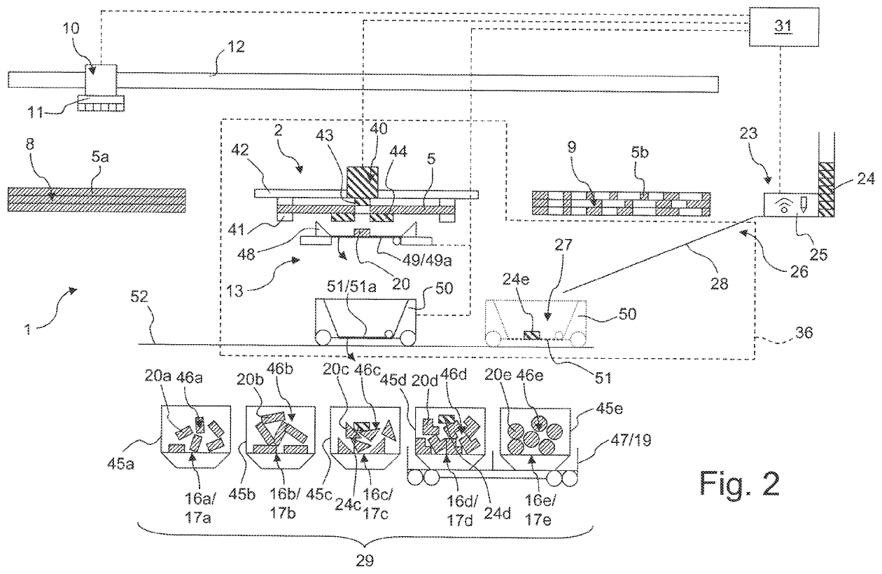

FIGS. 1 and 2 show a conveying unit 36. The conveying unit 36 is generally configured to convey the identifying elements 24 from the provision device 23 to the workpieces 20, 20a, 20b, 20c and/or to a workpiece collection unit 17a-17e. The conveying unit 36 can include at least the automation device 13 and the conveying device 26.

FIG. 2 shows another embodiment of a production station 1. The functionality is similar to the embodiment in FIG. 1, and the essential differences are primarily explained in the following.

In the production station 1, the production machine 2 can be a punching machine including a punching head 40, by which workpieces 20 can be punched out of a piece of raw material 5 to be punched. To position the piece of raw material 5 for punching out different workpieces 20, the piece of raw material 5 is held in place by a clamping device 41 which can be moved in a horizontal plane by a gantry system 42; in addition, the piece of raw material 5 can be supported on a table in a sliding manner. The punching tool 43 and punching die 44 of the punching machine can be replaced for different types of workpieces 20 to be punched.

By the loading device 10, unpunched pieces of raw material 5a can be brought to the clamping device 41 from the stack 8 of raw material, and leftover pieces of raw material 5b can be brought to the stack 9 of leftover material from the clamping device 41.

In the example shown, punched-out workpieces 20 are brought to five workpiece collection apparatuses 17a-17e at provision locations 16a-16e by the automation device 13, the workpiece collection units 17a-17e being containers 45a-45e. The workpieces 20a-20e form piles (fills) 46a-46e in the containers 45a-45e. The containers 45d and 45e are arranged on a roller carriage 47. The roller carriage 47 thus constitutes a workpiece collection apparatus 19 including two workpiece collection units 17d, 17e.

Here, the automation device 13 includes a workpiece funnel 48 that forms a floor-side ejector 49 that has a flap 49a. A punched-out workpiece 20 initially remains on the closed flap 49a. When a workpiece carriage 50 is positioned below the ejector 49, the ejector 49 can be opened and the workpiece 20 (optionally multiple workpieces) drops into the workpiece carriage 50. The workpiece carriage 50 is in turn provided with a floor-side ejector 51 that is has a flap 51a. The workpiece carriage 50 can be moved above the provision locations 16a-16e or the workpiece collection units 17a-17e on a guide 52 that can be positioned over a selected provision location 16a-16e. The ejector 51 can then be opened and the workpiece 20 (or workpieces) drops out of the workpiece carriage 50 into the containers 45a-45e therebelow at the selected provision location 16a-16e. The roller carriage 50 in the non-dotted view is positioned for receiving workpieces 20 from the workpiece funnel 48 and also for letting workpieces 20 drop into the central container 45c.

In the rightmost movement position (shown by dotted lines) of the workpiece carriage 50, an identifying element 24, which has been written with direct information regarding the workpieces 20a-20e on a workpiece collection unit 17a-17e and/or with an individual (unique) allocation identifier for this information in the provision device 23 including a writing device 25, can slide down a chute 28 of the conveying device 26 into the workpiece carriage 50. When it is arranged in the rightmost position of the guide 52, the interior of the workpiece carriage 50 forms a transfer zone 27 for the identifying elements 24 in the working region 29 of the automation device 13. By the workpiece carriage 50, an identifying element 24e can then be moved above a desired container 45a-45e and can drop into the container by opening the ejector 51. To have the identifying element 24e drop into the associated workpiece collection unit 17e, the workpiece carriage 50 does not need to be moved. Identifying elements 24c, 24d have already been sorted into the containers 45c and 45d. The chute 28 can alternatively be configured such that an identifying element 24 that is sliding down drops into the workpiece funnel 48.

The control device 31 in turn coordinates the loading device 10, the production machine 2, the automation device 13, and the provision device 23 to bring about the production and sorting of the workpieces 20, 20a-20e and the writing or allocation and sorting of the identifying elements 24, 24c-24e. Here, the automation device 13 are actuated both in relation to the movement position of the workpiece carriage 50 and also in relation to the opening (and closing) of the ejectors 49, 51.

FIG. 3 shows, by way of example, an identifying element 24 provided by the provision device 23. The identifying element 24 is a plastics card 67, which in this case has a length of approximately 90 mm, a width of 50 mm, and a thickness of 4 mm. The thickness of the card 67 is usually 1/10 or less of both the length and the width of the card 67. In many cases, the thickness of the card 67 can be 1.5 mm or less. Usually, however, the card 67 is at least 0.6 mm or at least 1.0 mm thick.

The identifying element 24 has been printed, by the provision device 23, on the upper face with direct information 60 regarding the workpieces on a workpiece collection unit to which the identifying element 24 is allocated. The identifying element 24 is placed on the workpieces on the associated workpiece collection unit by the automation device for the workpieces.

The printed information 60 includes a type number of the workpieces 61, a production date of the workpieces 62, a name of a customer 63 that has placed the order as well as an order number 64. The printed information 60 is easy for a human to read with the naked eye.

An RFID chip 65 is welded into the identifying element 24, e.g., into the plastics card 67. The RFID chip 65 can alternatively also be fastened to the identifying element 24 in another manner, for example bonded thereto. The RFID chip 65 has been written (programmed), by the provision device 23, with the same information 60 regarding the workpieces on the associated workpiece collection apparatus as has been printed. This direct information 60 is also available to be read out by a machine, e.g., contactlessly, using an RFID reader.

The information on the RFID chip 65 can be more comprehensive than the information 60 that has been printed, and for example can contain data regarding the production station used to manufacture the workpieces.

The upper face of the identifying element 24 provides a planar portion 66 on which a suction gripper can act to grip and transport the identifying element 24. The same applies to the underside.

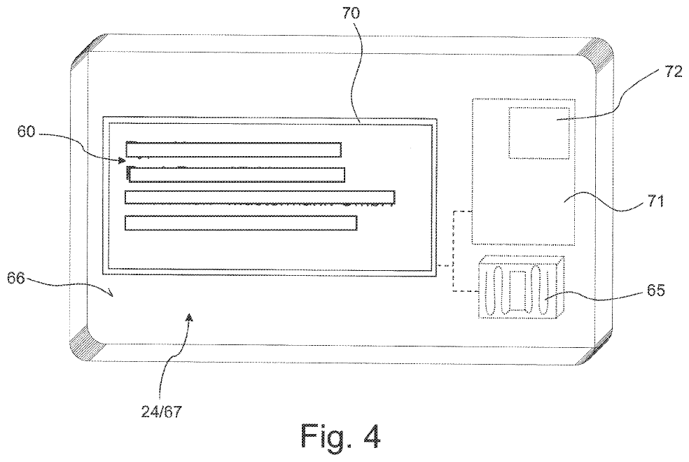

Alternatively, the identifying element 24 can also be a card 67 that includes an electronically changeable display 70 for displaying the information 60 (see FIG. 4). Cards 67 that use what is known as e-paper (e-ink) as a display 70 are particularly economical in terms of power consumption. They are actuated by a control module 71 of the identifying element 24, which can change the display 70. The then static display 70 itself does not consume any electrical power. The control module 71 includes a receiver 72 that receives electromagnetic signals such as radio waves, light, or infrared. The information 60 can be conveyed (transmitted) to the control module 71 (e.g., wirelessly), by the electromagnetic signals. The module can display the information 60 on the e-ink display 70 such that it can be read by humans. The (direct) information 60 regarding the workpieces can be transmitted to the identifying element 24 in the provision device. Alternatively, the (direct) information 60 can be transmitted at a later stage, for example in a workshop, by a suitable transmitting module. The identifying elements 24 can be unambiguously allocated by an allocation identifier (for example stored on the RFID chip 65) to the associated workpiece collection units or the corresponding information 60 regarding the workpieces thereon. Such an identifying element 24 is characterized by a very high level of flexibility.

The methods and devices described are suitable for bend-resistant workpieces 20, 20a-e. A bend-resistant workpiece can be made of sheet metal, glass, or plastics material. Parts cut (or punched) out of a semiconductor substrate or a printed circuit board are often bend-resistant.

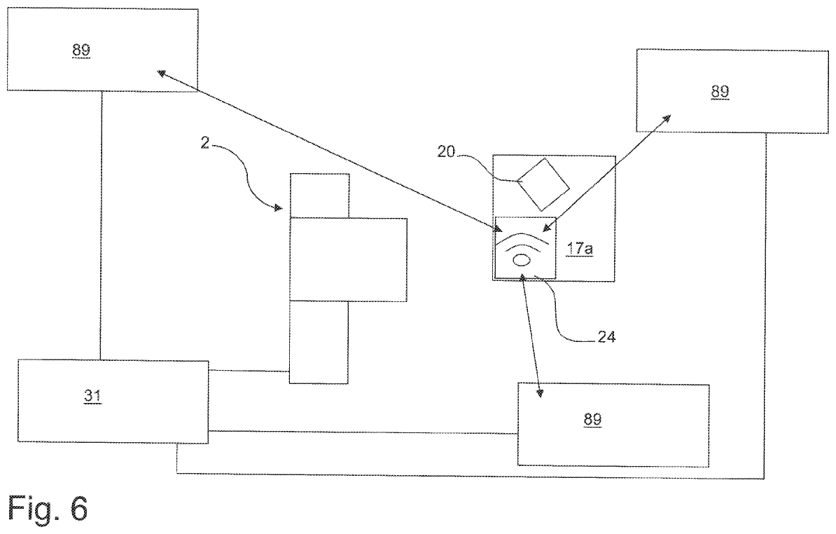

FIG. 6 is a schematic plan view of a production facility. A production machine 2 is arranged in the production facility. The production machine 2 is controlled by a control device 31. The control device 31 in turn controls transceiver units 89. The transceiver units 89 are capable of exchanging electromagnetic signals (shown by double-headed arrows in FIG. 6) with an identifying element 24 in the form of a mobile unit. The identifying element 24 is arranged in, at, or on a workpiece collection unit 17a. The workpiece collection unit 17a in turn includes a workpiece 20. The workpiece 20 can then be indirectly accurately located by the identifying element 24. If the identifying element 24 is in the proximity of the production machine 2, the control device 31 can actuate or book the production machine 2 to process the workpiece 20. The identifying element 24 allocated to the workpiece collection unit 17a by the automation device 13 (not shown in FIG. 6) is thus capable of rendering production more transparent and effective overall.

A method for identifying workpieces 20, 20a-20e, wherein a production machine 2 produces a plurality of workpieces 20, 20a-20e and the produced workpieces 20, 20a-20e are distributed to multiple workpiece collection units 17a-17e in a sorted manner, includes that the produced workpieces 20, 20a-20e are brought to the workpiece collection units 17a-17e using an automation device 13, wherein identifying elements 24, 24a-24e in the form of mobile units for emitting and receiving electromagnetic signals to and from transceiver units 89 are arranged on the workpiece collection units 17a-17e to determine the position of the identifying elements 24, 24a-e from propagation times of the electromagnetic signals between the transceiver units 89 and the identifying elements 24, 24a-e. The identifying elements 24, 24a-e each directly and/or indirectly bear information 60 regarding the workpieces 20, 20a-20e on the workpiece collection units 17a-17e, and the identifying elements 24, 24a-24e provided by a provision device 23 which each directly and/or indirectly bear information 60 regarding the workpieces 20, 20a-20e on the workpiece collection units 17a-17e are brought from the location of the provision device 23 to the associated workpiece 20, 20a-20e and/or the associated workpiece collection unit 17a-17e by a conveying unit 36. The conveying takes place at a transfer zone 27 in the working region 29 of the automation device 13, wherein the automation device 13 brings a particular provided identifying element 24, 24a-24e from the transfer zone 27 to the associated workpiece collection unit 17a-17e. The invention makes it possible to identify workpieces 20, 20a-20e in a simple and cost-effective manner for it to be possible to locate them in real time.

### Other Embodiments

A number of embodiments of the invention have been described. Nevertheless, it will be understood that various modifications may be made without departing from the spirit and scope of the invention. Accordingly, other embodiments are within the scope of the following claims.

What is claimed is:

1. A method for identifying workpieces that are distributed to multiple workpiece collection units in a sorted manner, the method comprising:
moving the workpieces to the workpiece collection units using an automation device,
moving identifying elements from a provision device to an associated workpiece or an associated workpiece collection unit by a conveying unit,
wherein the identifying elements bear information regarding the workpieces, wherein the identifying elements are on one or both of the workpieces and the workpiece collection units, and wherein the identifying elements are in the form of mobile units for emitting and receiving electromagnetic signals to and from transceiver units, and
determining the position of the identifying elements from propagation times of the electromagnetic signals between the transceiver units and the identifying elements.

2. The method of claim 1, wherein the identifying elements each bear an individual allocation identifier, and wherein information regarding the workpieces on the workpiece collection units are allocated in a database to the allocation identifiers.

3. The method of claim 2, wherein the provision device is configured to read the allocation identifier stored on each of the identifying elements.

4. The method of claim 2, wherein the provision device is configured to remove the identifying elements from a store, the identifying elements have known, permanently stored allocation identifiers stored in a known order in a stack, and wherein an allocation identifier for an identifying element is determined by removal information that describes the position of the identifying element relative to the known order and the removal information is a number index of the identifying elements taken from the stack.

5. The method of claim 1, wherein the provision device writes the identifying element in a machine-readable manner and/or in a manner that is readable by humans.

6. The method of claim 1, wherein the provision device describes the identifying element in a reversible manner.

7. The method of claim 1, comprising moving the identifying elements to a transfer zone in the working region of the automation device, and wherein the automation device moves a particular provided identifying element from the transfer zone to the associated workpiece or the associated workpiece collection unit.

8. The method of claim 1, wherein the automation device piles a stack of workpieces on at least one of the workpiece collection units and applies an identifying element on top of or beside the stack of workpieces, wherein at least one of the workpiece collection units comprises a pallet or a partial region of a pallet on which the stack is piled.

9. The method of claim 1, wherein the automation device piles workpieces at least on one of the workpiece collection units and applies an identifying element on top of or beside the pile of workpieces, wherein at least one of the workpiece collection units comprises a container in which the pile is formed.

10. The method of claim 1, wherein the automation device comprises gripping devices that grip the workpieces and the identifying elements.

11. The method of claim 1, wherein the automation device comprises a workpiece carriage into which the workpieces and identifying elements are placed and is configured to move at least over some of the workpiece collection units, and, by opening an ejector, drop the workpieces and the identifying elements out to a workpiece collection unit.

12. The method of claim 1, wherein the identifying elements are configured to emit and receive ultra-wideband signals.

13. The method of claim 1, wherein determining the position of the identifying elements comprises using a propagation time of the electromagnetic signals between the transceiver units and the identifying elements.

14. A production station for workpieces, comprising:
a production machine for producing a plurality of workpieces,
an automation device for bringing the workpieces produced by the production machine to provision locations for workpiece collection units,
a control device configured to actuate the automation device to distribute the produced workpieces to the provision locations in a sorted manner,
a plurality of identifying elements configured to emit and receive electromagnetic signals to and from transceiver units and determine the position of the identifying elements from propagation times of the electromagnetic signals between the transceiver units and the identifying elements,
a provision device for providing the identifying elements, wherein the identifying elements bear information regarding the workpieces sorted to the provision locations, and
a conveying unit for bringing the identifying elements from the provision device to the provision locations,
wherein the control device is further configured to actuate the conveying unit such that the identifying elements are sorted to the relevant provision location of the workpieces for which they bear information.

15. The production station of claim 14, wherein the provision device comprises a writing device for writing the identifying elements directly with the information for the workpieces sorted to each of the provision locations and/or with an allocation identifier for this information.

16. The production station of claim 14, wherein the provision device comprises one or both of:
a reading device for reading allocation identifiers that are stored in the identifying elements, and
a determining device for determining the position of an identifying element relative to a known order, wherein the identifying elements are stored in a stack and the determining device comprises a counting device for identifying elements taken from the stack.

17. The production station of claim 14, wherein the conveying unit comprises:
a conveying device for bringing the identifying elements from the provision device to a transfer zone in the working region of the automation device, wherein the automation device is configured to move the provided identifying elements from the transfer zone to the provision locations, and wherein the control device is configured to actuate the automation device such that the identifying elements are sorted to the relevant provision location of the workpieces for which they bear information.

18. The production station of claim 17, wherein the conveying device comprises a chute via which the provided identifying elements can slide from the provision device into the transfer zone in the working region of the automation device.

19. The production station of claim 14, wherein the production machine is a flat-bed processing machine, a laser-cutting machine, or a punching machine, or a combined cutting and punching machine, or a bending machine.

20. The production station of claim 14, wherein the automation device comprises a suction gripper, and the identifying elements comprise a planar portion for applying the suction gripper.

21. The production station of claim 14, wherein at least some of the workpiece collection units are a pallet, and/or a partial region of a pallet, and/or a container.

22. The production station of claim 21, further comprising at least one workpiece collection apparatus comprising a plurality of workpiece collection units that are transported together over the workpiece collection apparatus.
